(19) United States
(12) Patent Application Publication
(10) Pub. No.: US 2007/0140769 A1
(43) Pub. Date: Jun. 21, 2007

(54) PRINTER

(75) Inventor: Haruo Hasegawa, Shinagawa-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/613,616

(22) Filed: Dec. 20, 2006

(30) Foreign Application Priority Data
Dec. 20, 2005 (JP) 2005-366848
Nov. 24, 2006 (JP) 2006-317016

(51) Int. Cl. B41J 25/308; B41J 25/304

(52) U.S. Cl. 400/56; 400/124.01

(57) ABSTRACT

The present invention provides a printer that includes a clearance gauge which is made of resin, and has formed thereon a cut at the sliding range of platen rollers, which cut extends in a direction perpendicular to the sliding direction. The width of the cut is set up by taking the maximum step raised in printing operations into consideration. In addition to forming the cut, the member has formed thereon an opening that communicates with the cut.

### CROSS REFERENCES TO RELATED APPLICATIONS

This application is based upon and claims the benefit of priority from the prior Japanese Patent Applications No. 2005-366848, filed on 20th Dec., 2005, and No. 2006-317016, filed on 24th Nov., 2006, the entire contents of which are incorporated herein by reference.

### BACKGROUND OF THE INVENTION

1. Field of the Invention

The present invention relates to a printer, and more particularly, to a serial dot printer, etc. that is provided with a platen gap keeping means for keeping the gap between a printing medium and a platen.

2. Description of the Related Art

There have been widely employed printers which perform printing processing on various printing media such as certificates, passbooks, general forms, etc. In such printers, since the thickness of a printing medium changes every time each page is turned over, a head gap adjustment device that can properly set up the head gap of a printer is employed so as not to damage the printing medium. (For example, Jpn. Pat. Appln. Laid-Open Publication No. 2003-159851)

The head gap adjustment device includes a biasing means for biasing a print head to the side of a platen, a gap setup means that is made to abut on a printing medium by biasing forces of the biasing means so as to set up the gap between the print head and the printing medium, and an auxiliary means such as auxiliary rollers which are arranged in the carriage scanning direction of the gap setup means, so that the bump angle to the edge of the printing medium is reduced to make it possible to smoothly ascend to the printing medium.

As described above, so as to uniformly keep the gap between a print head and a fixed platen, for example, a clearance gauge, etc is intermediately arranged to adjust the gap. However, at a thickness step or bound portion of a printing medium, when platen gap rollers ascend to the edge of the printing medium, shearing forces are applied to the clearance gauge, sometimes bringing about cracks or fractures. In the work for replacing thus damaged clearance gauge, the entire functions of a printer has to be suspended, which raised a problem in maintenance.

### BRIEF SUMMARY OF THE INVENTION

It is an object of the present invention to provide a printer that is provided with a platen gap keeping means for keeping the gap between a printing medium and a platen.

In an aspect of the present invention, there is provided a printer that performs printing processing on a printing medium, which includes: a print head; a platen; platen gap rollers which are attached to the print head; and a member that keeps the gap between the platen rollers and the platen; wherein the member has formed thereon a cut at the sliding range of the platen rollers, the cut extending in a direction perpendicular to the sliding direction.

### BRIEF DESCRIPTION OF THE DRAWINGS

FIG. 1 shows a schematic view indicative of the entire configuration of a printer according to an embodiment of the present invention;

FIG. 2 shows a view to explain the substantial part of the printer;

FIG. 3 shows a view to explain the relationship between a printing medium and a clearance gauge; and

FIG. 4 shows a view indicative of an example of the clearance gauge.

### DETAILED DESCRIPTION OF THE INVENTION

Throughout this description, the embodiments and examples shown should be considered as exemplars, rather than limitations on the apparatus and methods of the present invention.

Hereinafter, an embodiment of the printer according to the present invention will further be described below with reference to the accompanying drawings.

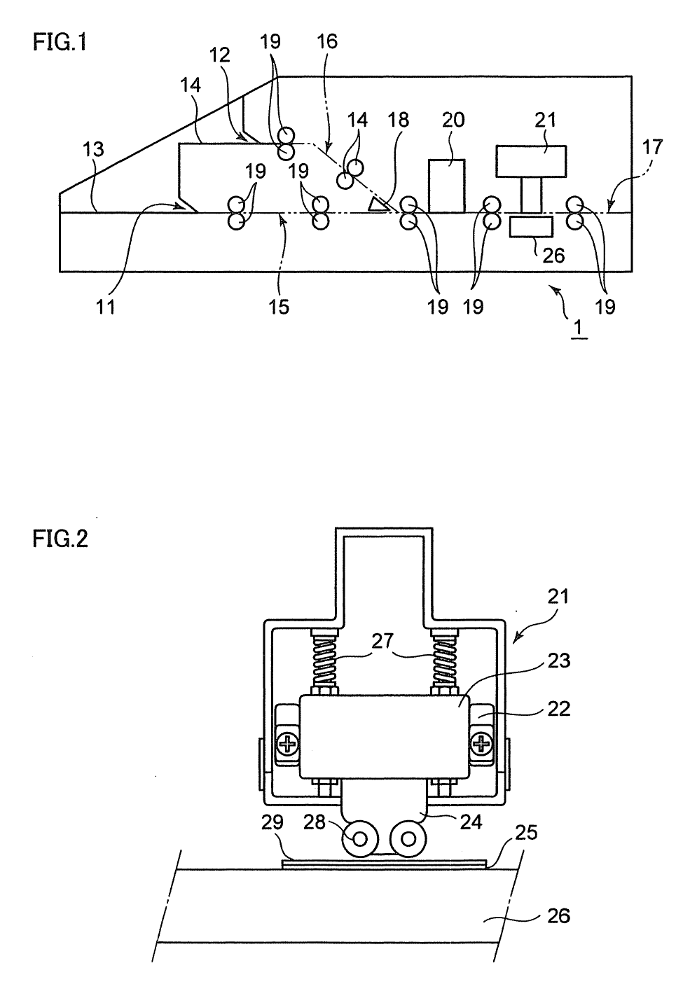

FIG. 1 shows a schematic view indicative of the entire configuration of a printer 1 according to an embodiment of the present invention. At the frame of the printer 1, there are formed media treating ports 11, 12 that take in and send out a printing medium such as a passbook, respectively, at the upper and lower parts of the printer 1. There is formed a lower-side table 13 at a position corresponding to the lower-side media treating port 11, while an upper-side table 14 is formed at a position corresponding to the upper-side media treating port 12. On these lower-side table 13 and upper-side table 14, a printing medium put in the inside of the printer 1 is placed, and a printing medium discharged from the inside of the printer 1 is placed.

To the lower-side media treating port 11, a feeding path (referred to as first feeding path, hereinafter) 15 extending to the rear side (right side in FIG. 1) of the printer 1 is connected. Similarly, to the upper-side media treating port 12, a feeding path (referred to as second feeding path hereinafter) 16 extending to the rear side of the printer 1 is connected. Then, the first and second feeding paths 15 and 16 link together, forming a predetermined angle, and there is formed, after the link, a feeding path (referred to as third feeding path hereinafter) 17 further extending to the rear side of the printer 1. At the link point where the first feeding path 15 and the second feeding path 16 link together to be connected to the third feeding path 17, there is arranged a feeding path switching mechanism 18 that selectively switches the first and second feeding paths 15 and 16 with respect to the third feeding path 17 so as to switch the feeding direction.

Each of the first, second, and third feeding paths 15, 16, and 17 is provided with a plurality of feeding rollers 19. These rollers 19 are made to rotate forward and backward by a motor, not shown, to feed a printing medium placed on the lower-side table 13 and upper-side table 14 to the inside (right side in FIG. 1) or to the outside (left side in FIG. 1) of the printer 1. The third feeding path 17 is provided with a photoscanner 20 that scans information of a printing medium, and a carriage 21 having loaded therein a print head that prints out data on a printing medium.

FIG. 2 shows a view to explain the substantial part of the printer 1. In FIG. 2, a driving force is transmitted to the carriage 21, and the carriage 21 is made to shift in the main scanning direction (right and left directions in FIG. 2). The carriage 21 has loaded therein a head holder 22, and has mounted thereto a print head 23 of the impact type through the head holder 22. The print head 23 is so configured as to selectively project a plurality of needles from the leading end, not shown, of a nose 24 using driving signals. Characters and images are printed out when dots are formed on a printing medium 25 by impact forces of the needles through an ink ribbon, etc., and the carriage 21 is made to shift in the main scanning direction, while the printing medium 25 is made to shift in the sub-scanning direction by rollers, not shown. Under the print head 23, a platen 26 that fluctuates upward and downward is so arranged as to face the print head 23, and the platen 26 supports the printing medium 25 from the non-printing side thereof.

The print head 23 is biased to the side of the platen 26 by compression springs 27 attached to the inside of the carriage 21.

To the nose 24 of the print head 23, platen rollers 28 for setting up the gap are so attached as to be rotatable in the main scanning direction. With respect to the leading end of the nose 24, the lower ends of the platen rollers 28 protrude to the side of the platen 26, and the protrusion amount is set to a predetermined value suitable for printing processing. The platen rollers 28 keep the state of abutting on the platen 26 or printing medium 25 by biasing forces of the compression springs 27, which can constantly keep the gap between the leading end of the nose 24 and the printing medium 25 at a clearance suitable for printing processing.

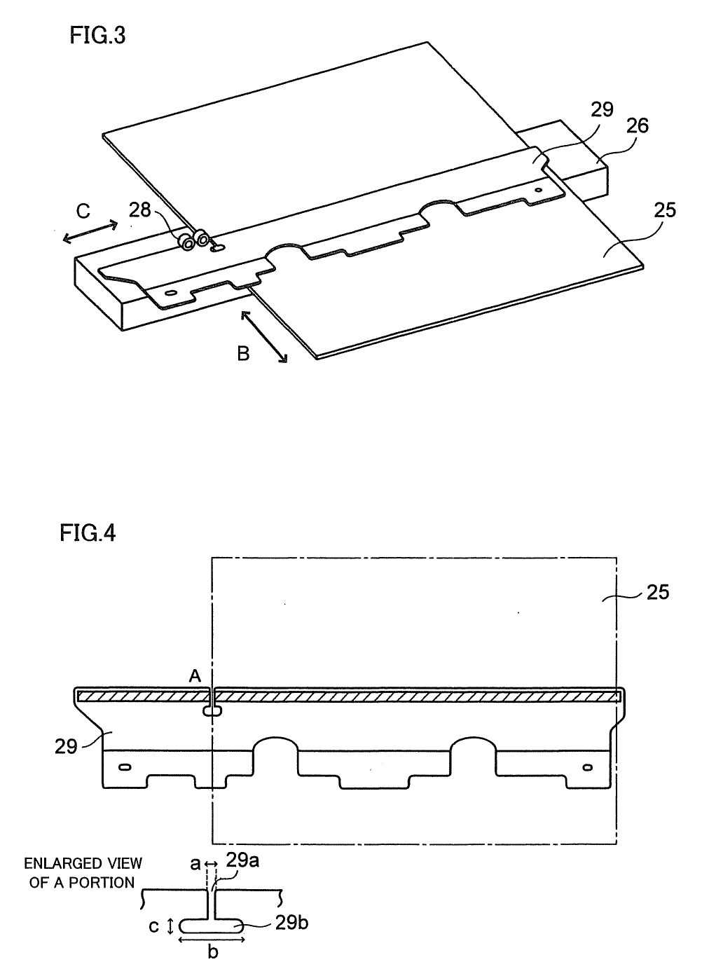

Next, a member 29 to keep the platen gap will be explained. As shown in FIG. 3, the member 29 is arranged between the printing medium 25 such as a passbook placed on the platen 26 and the platen rollers 28. The printing medium 25 that is inserted between the platen 26 and the member 29 is shifted in the “B” direction in FIG. 3. The print head 23 is made to shift in the “C” direction which is perpendicular to the feeding direction. FIG. 4 shows a view of an example of the member 29.

The printing medium 25 such as a passbook is of notebook type and is composed of a plurality of pages, and the height (thickness) of the printing medium 25 from the front cover surface thereof to the printing surface thereof changes every time the page is turned over.

So as to surely perform printing processing using the print head 23, as a member to keep the gap between the platen 26 and the printing surface of the printing medium 25 at a predetermined clearance, the member 29 is intermediately arranged.

As shown in FIG. 3, in printing processing, the platen rollers 28 ascend to the printing medium 25 such as a passbook, and the print head 23 shifts to a desired position of the printing medium 25. There are differences in level not only in ascending to the printing medium 25 but also in shifting from the left side page to the right side page of the notebook as well as in descending from the printing medium 25. Accordingly, repetitive shearing forces are applied to the member 29.

The member 29 according to the embodiment of the present invention has formed thereon a cut 29a as shown in an enlarged view of A portion at the sliding range of the platen rollers 28 represented by the shaded area in FIG. 4, which cut 29a extends in a direction perpendicular to the sliding direction. It is desirable that the member 29 is made of PET resin, polyethylene resin, etc. The width “a” of the cut 29a can be set up by taking the maximum step raised in printing processing into consideration. For example, the width “a” may be set to 0.5 mm. The printing medium 25 is fed with its edge shifting along the cut 29a.

In addition to forming the cut 29a, it is desirable that the member 29 has formed thereon an opening 29b that communicates with the cut 29a. The reason is to further let out shearing forces effectively. The opening 29b is, for example, in the shape of an elongated hole, as shown in FIG. 4. In case of an elongated hole, the width “b” of the opening in a direction perpendicular to the feeding direction for feeding the printing medium 25 is equal to or larger than the width “c” of the opening in the feeding direction, that is, b>c. For example, the “b” is set to 5.5 mm, while the “c” is set to 3 mm (refer to FIG. 4). The shape of the opening 29b is not limited, and may be an oval hole or a circular hole.

Furthermore, the length of the cut 29a should be set up by taking the width of the platen roller 28 into consideration. It is desirable that the length from the leading end of the cut 29a to the center of the opening 29b is approximately two times the width of the platen roller 28.

In general, as the type of a passbook as a printing medium, when classifying in the opening direction, there are a longitudinal type and transverse type. Accordingly, step-raising positions of these two types are different. So, in order to correspond to various types of printing media, the member may have formed thereon the cut at a plurality of positions which are separated by the width of passbooks.

Furthermore, instead of forming a cut on the member, by forming a first surface and a second surface, the heights of which are different by an amount corresponding to the thickness of a printing medium in advance, shearing forces raised in the member can be significantly reduced when the platen rollers ascend to the printing medium.

By the configuration described above, shearing forces which are generated due to the thickness step or bound portion of a printing medium can be significantly reduced. Thus, the bendability and the resistance to shearing forces of the member that keeps the platen gap are significantly improved. The length of life of the member until it is damaged is extended three times more than the case in which no cut is formed, significantly improving the maintenance property of the printer.

Although exemplary embodiments of the present invention have been shown and described, it will be apparent to those having ordinary skill in the art that a number of changes, modifications, or alternations to the invention as described herein may be made, none of which depart from the spirit of the present invention. All such changes, modifications, and alternations should therefore be seen as within the scope of the present invention.

What is claimed is:

1. A printer for performing printing operations on a printing medium, comprising:
a print head;
a platen;
platen rollers which are attached to the print head; and
a member that keeps the gap between the platen rollers and the platen;
wherein the member has formed thereon a cut at the sliding range of the platen rollers, the cut extending in a direction perpendicular to the sliding direction.

2. The printer according to claim 1, wherein
the printing medium is fed with its edge shifting along the cut.

3. The printer according to claim 1, wherein
the member has formed thereon a first surface and a second surface, the heights of which are different by an amount corresponding to the thickness of the printing medium.

4. The printer according to claim 2, wherein
the member has formed thereon the cut at a plurality of positions in order to correspond to various types of printing media.

5. The printer according to claim 2, wherein
the member has formed thereon an opening that communicates with the cut.

6. The printer according to claim 4, wherein
the member has formed thereon an opening that communicates with the cut.

7. The printer according to claim 5, wherein
the opening is any of an elongated hole, a circular hole, and an oval hole.

8. The printer according to claim 6, wherein
the opening is any of an elongated hole, a circular hole, and an oval hole.

9. The printer according to claim 7, wherein
the width of the opening in a direction perpendicular to the feeding direction for feeding the printing medium is equal to or larger than the width of the opening in the feeding direction.

10. The printer according to claim 8, wherein
the width of the opening in a direction perpendicular to the feeding direction for feeding the printing medium is equal to or larger than the width of the opening in the feeding direction.
